(19) United States
(12) Patent Application Publication
(10) Pub. No.: US 2008/0075057 A1
(43) Pub. Date: Mar. 27, 2008

(54) FREQUENCY CORRECTION BURST DETECTION

(75) Inventors: Ming-Luen Liou, Zhonghe County (TW); Rong-Liang Chiou, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/534,871

(22) Filed: Sep. 25, 2006

(51) Int. Cl. H04B 7/216

(52) U.S. Cl. 370/342

(57) ABSTRACT

A system for detecting a regularly appearing pattern in a stream of symbols. The system comprises a detector, a first and second memory, a first and second pointer, and a processor. The detector compares detecting bits with a predetermined value, and generates a detection signal when the received symbol is equal to the predetermined value. The first memory array has K cells, and the second memory array has W cells. The first pointer circularly points to each cell of the first memory array in order. The second pointer does the same. The count value of the cell pointed to by the first or second pointer is incremented by one when the detection signal is received. The processor determines whether the regularly appearing pattern is detected or not according to the count values of the first and the second memory array.

### BACKGROUND OF THE INVENTION

### Field of the Invention

The invention relates to packet segmentation, and in particular relates to detecting a target symbol in a stream of symbols.

Packet segmentation is an important issue in processing MPEG stream data. FIG. 1 shows an example of the structure of an MPEG stream. The MPEG stream 10 consists of a plurality of MPEG packets 12. An MPEG packet 12 has 188 bytes, with one byte for synchronization purposes, three bytes of header containing service identification, scrambling and control information, followed by 184 bytes of MPEG or auxiliary data. The first byte of an MPEG packet is specified to be a sync byte having a constant value of 47ₕₑₓ. The sync byte is usually utilized as an indicator. FIG. 2 shows an example of an MPEG stream to delineate an MPEG packet from an MPEG stream. The cross-strap area represents the sync bytes of MPEG packets. Other shaded areas represent bytes that have the same value as the sync byte. Sync bytes appear regularly, but the others appear randomly. Thus, a delineating module uses the difference to delineate an MPEG packet from a stream.

Typically, to delineate a packet from a stream requires a memory array. Each time a byte with 47ₕₑₓ appears, the memory array is updated to record when and how often the target byte appears. For example, a memory array having 188 cells is provided. A stream with 47ₕₑₓ appears at locations 3, 50, 191, 200, and 379. The memory array notes a “1” at a cell representing location 3, then, notes a “1” at location 50. At time 191, which is 188 plus 3, the memory array updates the cell representing location 3. At location 200, the memory array changes its record at a cell representing location 12. At location 379, which is two times 188 plus 3, the memory array updates the cell representing location 3 again. So far, a delineator can predict that the next sync byte will appear at location 567. In other words, the sync bytes appear at location q*188+3, where q is an integer number. 47ₕₑₓ showing up at other locations is probably a non-sync byte. The complexity of the method is low, but it requires the memory to be as long as a packet length.

The interface should maintain a history of past occurrence of the synchronization pattern and evaluate the reliability of a timing position as the correct boundary of output packets. Conventionally, the reliability metrics are stored in a memory with a size equal to the number of possible locations, which is called the search window size and usually equals the size of the output packet. Thus, for large output packets, the interface device should have an equally large memory. In this invention, a method of using multiple small memories instead of one large memory to store the reliability metrics is disclosed. The number and sizes of the small memories have some relation to the search window size.

### BRIEF SUMMARY OF THE INVENTION

A detailed description is given in the following embodiments with reference to the accompanying drawings.

The method and system provided in the invention reduce the amount of memory required for storing reliability metrics without noticeable synchronization performance degradation.

A system for detecting a regularly appearing pattern in a stream of symbols is provided. Each pattern is a predetermined value, and the period of the plurality of regularly appearing patterns is N bits. The system comprises a detector, a first and a second memory array, a first and second pointer, and a processor. The detector receives a bit from the stream of symbols, combines the bit with previously received bits to form a plurality of detecting bits, compares the 8 bits with the predetermined value, and generates a detection signal when the detecting bits equal the predetermined value. The first memory array has K cells, and the second memory array has W cells. The first pointer initially points to a 1^{st} cell of the first memory array, then points to the next cell of the first memory array when a bit is received. When pointing to the K^{th} cell of the first memory array, the first pointer will next point to the 1^{st} cell of the first memory array again. The second pointer initially points to a 1^{st} cell of the second memory array, then points to the next cell of the second memory array when receiving a bit. When pointing to the W^{th} cell of the second memory array, the second pointer will next point to the 1^{st} cell of the second memory array again. The count value of the cell pointed to by the first or second pointer is incremented by one when the detection signal is received. The processor determines whether regularly appearing pattern is detected or not according to the count values of the first and the second memory array.

In other aspects, another system for detecting a regularly appearing pattern in a stream of symbols is provided. Each pattern is a predetermined value, and the period of the plurality of regularly appearing patterns is N bits. The system comprises a detector, a counter, a first and a second memory array, and a processor. The detector receives a bit from the stream of symbols, combines the bit with previously received bits to form a plurality of detecting bits, compares the detecting bits with the predetermined value, and generates a detection signal when the detecting bits equal the predetermined value. The counter increments a counter value when a bit is received. The first memory array has K cells, wherein each cell stores a count value. The second memory array has W cells, wherein each cell stores a count value. The processor coupled to the detector, the counter, the first and the second memory array, generates a first index by taking the remainder of dividing the count value with K, generates a second index by taking the remainder of dividing the count value with W, and increases the count value of a cell associated with the first index in the first memory array and increases the count value of a cell associated with the second index in the second memory array when receiving a detection signal, and determines whether the regularly appearing pattern is detected or not according to the count value of the first and the second memory arrays.

A method for detecting a regularly appearing pattern in a stream of symbols is provided. Each pattern is a predetermined value, and the period of the regularly appearing pattern is N bits. The method comprises generating a detection signal when the pattern is detected. A first memory array having K cells and a second memory array having W cell are provided. The product of W and K equal N. Each cell in the first and second memory arrays stores a count value. A first pointer initially points to a 1^{st} cell of the first memory array, then points to the next cell of the first memory array when receiving a symbol. When pointing to a K^{th} cell of the first memory array, the first pointer next will point to the 1^{st} cell of the first memory array again. The count value of the cell pointed to by the first pointer is incremented by one when the detection signal is received. A second pointer initially points to a 1^{st} cell of the second memory array, then points to the next cell of the second memory array when receiving streaming data. When pointing to a W^{th} cell of the second memory array, the second pointer next will points to the 1^{st} cell of the second memory array again. The count value of the cell pointed to by the second pointer is incremented by one when the detection signal is received. An index indicating that the regularly appearing pattern is detected is generated according to the count values of the first and second memory arrays.

In yet another aspect, an apparatus for detecting a periodically appearing pattern in a bit stream is provided. Each pattern is a predetermined value, and the period of the plurality of regularly appearing patterns is N bits. The apparatus comprises a detector, a first counter array, a second counter array, and a processor. The detector receives a bit of the bit stream, combines the bit with previously received bits to form a plurality of detecting bits, compares the detecting bits with the predetermined bits value, and generates a detection signal while the value of the detecting bits equal to the predetermined bits value. The detecting bits is of predetermined bit length and corresponds to a bits location in the bit stream, and the bits location is one of N possible bit locations. The first counter array has K counters, wherein each counter corresponds to a plurality of bits locations of N possible bits locations, and while receiving the detection signal the counter of the first counter array corresponding to the bits location of the detecting bits is increased by one. The second counter array has K counters, wherein each counter corresponds to a plurality of bits locations of N possible bits locations, and while receiving the detection signal the counter corresponding to the bits location of the detecting bit is increased by one. The processor determines whether the periodically appearing pattern is detected or not according to the counters of the first counter array and counters of the second counter array.

### BRIEF DESCRIPTION OF THE DRAWINGS

The invention can be more fully understood by reading the subsequent detailed description and examples with references made to the accompanying drawings, wherein:

FIG. 1 shows an example of the structure of an MPEG stream;

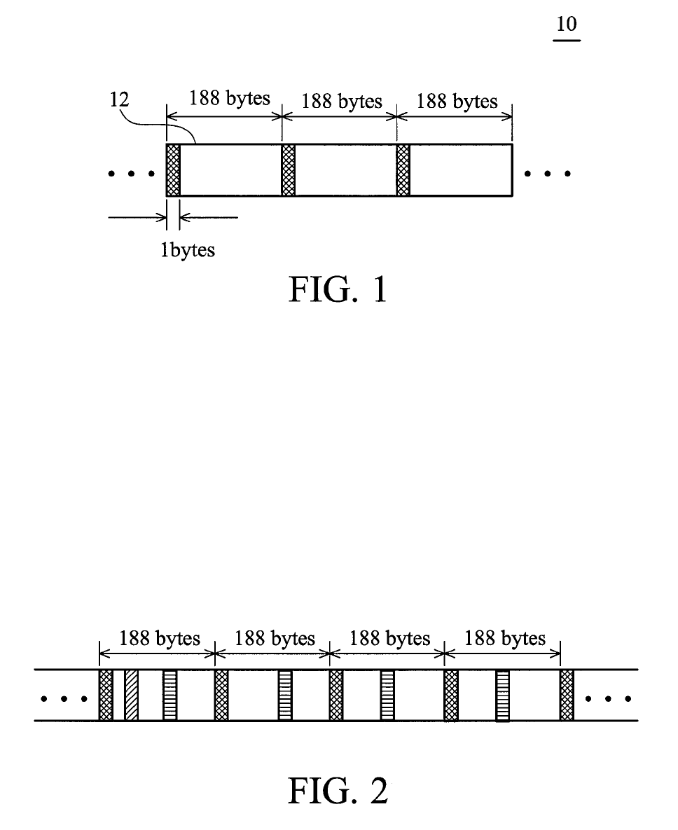

FIG. 2 shows an example of an MPEG stream;

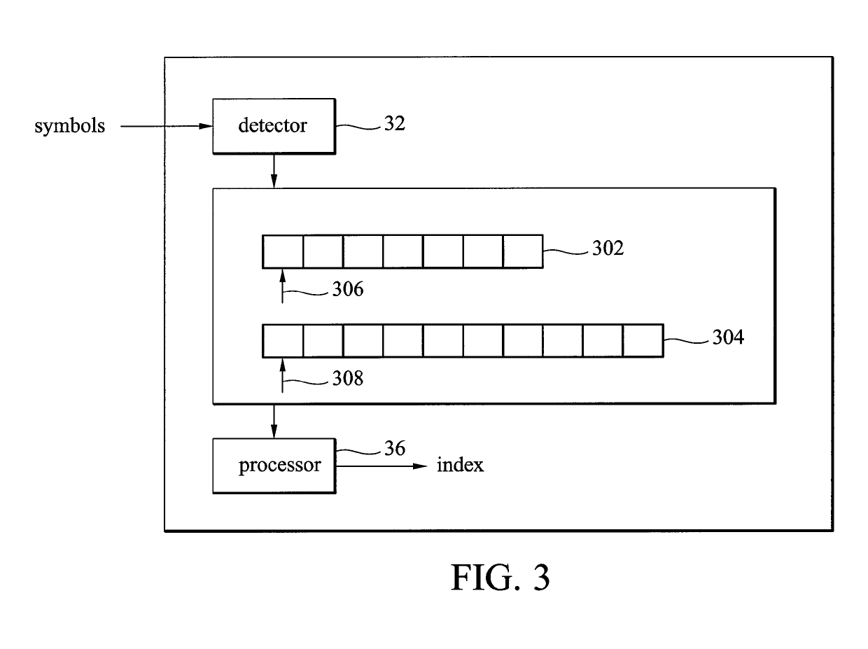

FIG. 3 shows a diagram of a system for detecting a regularly appearing pattern in a stream of symbols;

FIG. 4 illustrates that the two memories can be regarded as two axes;

FIG. 5 shows a diagram of a system for detecting a regularly appearing pattern in a stream of symbols; and

FIG. 6 shows a flowchart of the method according to the embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

For ease of explanation, the invention is described below as applied to detecting the sync pattern in an MPGE-2 transport packet. However, the invention is not limit to synchronizing MPEG-2 packets.

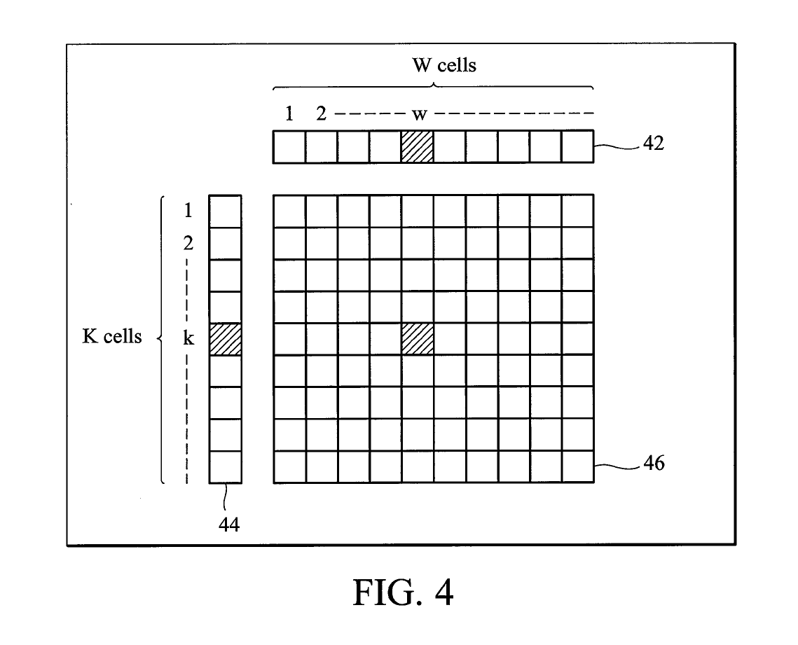

FIG. 3 shows a diagram of a system for detecting a regularly appearing pattern in a stream of symbols. Each pattern is a predetermined value, and the period of the regularly appearing pattern is N bits. Each symbol is of a predetermined bits length. In this embodiment of the invention, the stream of symbols is an MPEG-2 transport stream, the predetermined bits length is 8 bits and the predetermined value is 47_{HEX}. The system comprises a detector 32, a first memory array 302, a first pointer 306, a second memory array 304, a second pointer 308, and a processor 36. The detector 32 receives a bit from the stream of symbols, combines the bit with previously received bits to form a plurality of detecting bits, compares the detecting bits with the predetermined value, and generates a detection signal when the received symbol equals to the predetermined value. The detecting bits correspond to a bit location in the stream of symbols, and the bit location is one of N possible bit locations. The first memory array 302 has K cells, and the second memory array 304 has W cells, the product of K and W equals N. Each cell of the first memory array 302 and the second memory array 304 stores a count value. Each count value of the first memory array 302 and the second memory array 304 respectively corresponds to a plurality of bit locations. While the detecting bits are compared to be equal to the predetermined value, a count value of the first memory array which corresponds to the bit location of the detecting bits is incremented by 1, and a count value of the second memory array which corresponds to the bit location of the detecting bits also is incremented by 1. The detailed operation is described as following. The first pointer 306 initially points to a 1^{st} cell of the first memory array 302, then points to the next cell of the first memory array when a bit is received. When pointing to the K^{th} cell of the first memory array 302, the first pointer will next return to the 1^{st} cell of the first memory array 302 again. While the detection signal is asserted, the count value of the cell pointed to by the first pointer 306 is incremented by one when the first memory array 302. The second pointer 308 initially points to a 1^{st} cell of the second memory array 304, then points to the next cell of the second memory array 304 when a symbol is received. When pointing to the W^{th} cell of the second memory array, the second pointer 308 will next return to the 1^{st} cell of the second memory array again. While the detection signal is asserted, the count value of the cell pointed by the second pointer 308 is incremented by one. When the processor 36 detects that a cell in the first memory array 302 has a count value exceeding a first threshold and a cell in the second memory array 304 has a count value exceeding a second threshold, the processor 36 determines the regularly appearing pattern is detected. The processor 36 further calculate the location of the regularly appearing pattern by the formula:

location₁=w+W*(k−1), (1)

where the k^{th} cell in the first memory array 302 has a count value exceeding the first threshold, and the w^{th} cell of the second memory array 304 has a count value exceeding the second threshold. In another embodiment of the invention, the location can be calculated according to the following formula

location₂=k+K*(w−1). (2)

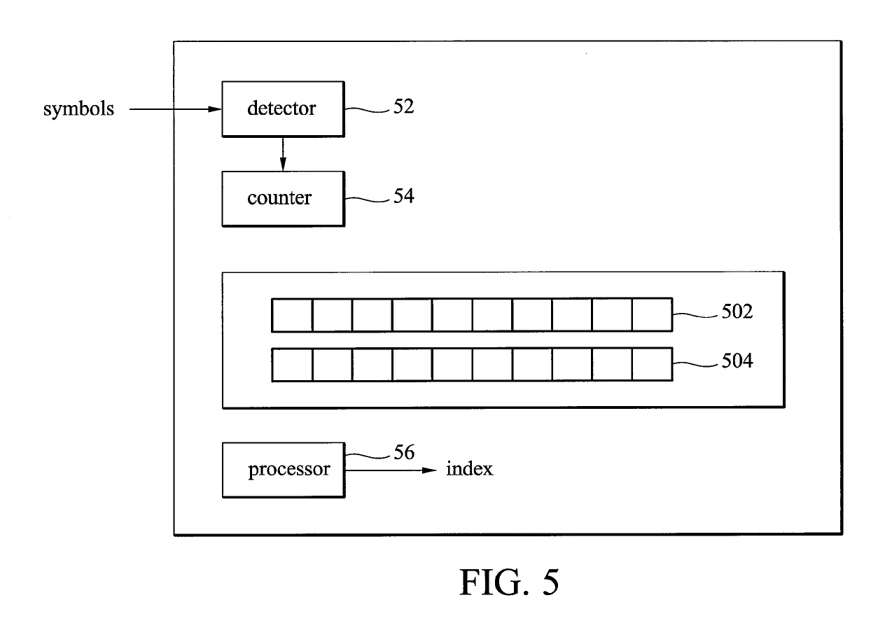

In this embodiment, the cell index of the first and second memory can be simulated as two coordinates of two axes. FIG. 4 illustrates that the two memories can be regarded as two axes. A virtual plane 46 is formed according to the two axes. Each cell in the virtual plane 46 represents a bits location, and each cell respectively corresponds to one cell of the first memory array 44 and one cell of the second memory 42. For example, the darken cell of the virtual plane 46 corresponds to the k^{th} cell of the first memory and the w^{th} cell of the second memory. While the count value of the k^{th} cell of the first memory array exceeding the first threshold and the count value of the w^{th} cell of the second memory array exceeding the second threshold, the bit location represented by the darken cell of the virtual plane 46 is determined as the location of the regularly appearing pattern. The virtual plane 46 can be regarded as folding the N bits locations into W columns and K rows.

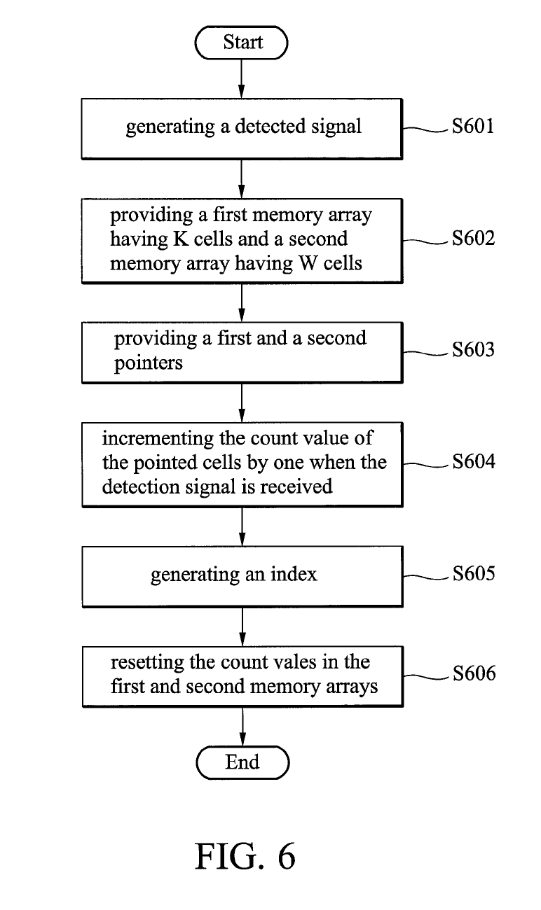

FIG. 5 shows a diagram of a system for detecting a regularly appearing pattern in a stream of symbols. Each pattern is a predetermined value, and the period of the plurality of regularly appearing patterns is N bits. Each symbol is of a predetermined bits length. In this embodiment of the invention, the stream of symbols is an MPEG-2 transport stream, the predetermined bits length is 8 bits and the predetermined value is 47_{HEX}. The system comprises a detector 52, a counter 54, a first memory array 502, a second memory array 504, and a processor 56. The detector 52 receives a bit from the stream of symbols, combines the bit with previously received bits to form a plurality of detecting bits, compares the detecting bits with the predetermined value, and generates a detection signal when the received symbol equals to the predetermined value. The counter 54 increments a counter value when a bit is received. The first memory array 502 has K cells and the second memory array 504 has W cells. Each cell in the first and second memory stores a count value. The product of K and W equals N. The processor 56 is coupled to the detector 52, the counter 54, the first and second memory array 502 and 504. The processor 56 generates a first index by taking the remainder of dividing the count value with K, and a second index by taking the remainder of dividing the count value with W. The count value of a cell in the first and second memory associated with the first and second index are increased when the processor receives a detection signal. When a cell in the first memory array has a count value exceeding a first threshold and a cell in the second memory array has a count value exceeding a second threshold, the processor determines the received symbol the regularly appearing pattern is detected. The processor further calculates the location of the regularly appearing pattern by the formula:

location₃=(w+1)+(W*k), (3)

where the count value of the k^{th} cell in the first memory array exceeds the first threshold, and the count value of the w^{th} cell in the second memory array exceeds the second threshold. In another embodiment of the invention, the location can be calculated according to the following formula:

location₄=(k+1)+(K*w). (4)

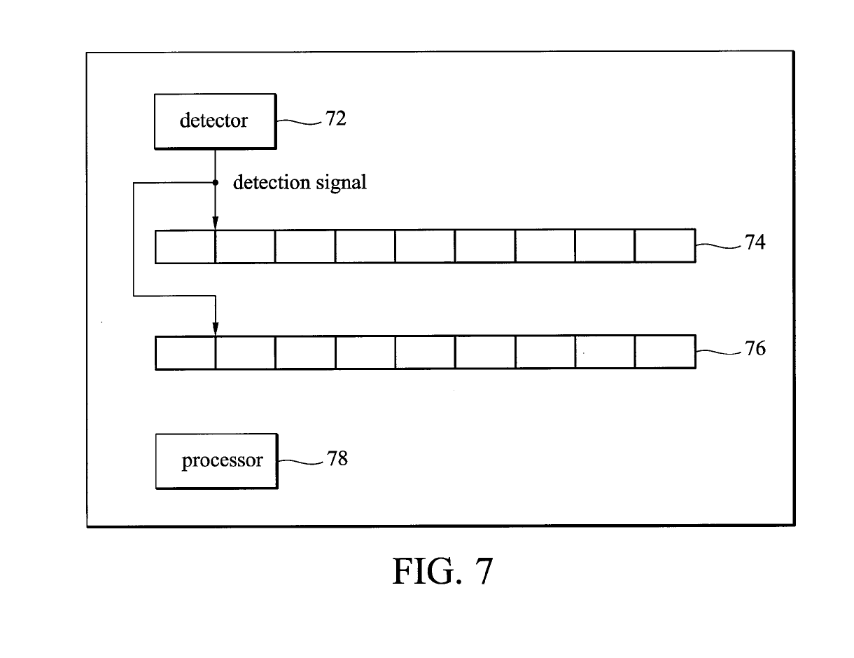

The invention further provides a method for detecting a plurality of regularly appearing patterns in a stream of symbols. Each pattern is a predetermined value, and the period of the plurality of regularly appearing patterns is N bits. In this embodiment, the stream of symbols is an MPEG-2 transport stream, and the predetermined value is 47_{HEX}. FIG. 6 shows a flowchart of the method. The method starts with generating a detected signal when detected a predetermined symbol in step S601. A first memory array having K cells and a second memory array having W cells are provided in step S602. Each cell stores a count value. The product of K and W equals the period N. A first and second pointer is then provided in step S603. The first pointer initially points to a 1^{st} cell of the first memory array, then points to the next cell of the first memory array when a bit is received. When pointing to an K^{th} cell of the first memory array, the first pointer will next return to the 1^{st} cell of the first memory array. A second pointer initially points to a 1^{st} cell of the second memory array, then points to the next cell of the second memory array when receiving streaming data. When pointing to a W^{th} cell of the second memory array, the second pointer will next return to the 1^{st} cell of the second memory array. In step 604, the count value of the cell pointed to by the first or second pointer is incremented by one when the detection signal is received. An MPEG-2 transport packet is 1504 bits, thus, in this embodiment, K is 47, and W is 32. This set of (K,W) allocates the smallest memory size. The invention, however, is not limited to the set of (K, W). Other sets such as (32, 47), (16, 94), (94, 16), (8, 188), and (188, 8), are also in scope of the invention. In step 605, an index indicating that the regularly appearing pattern has been detected is generated according to the count value of the first and second memory arrays. The index is calculated according to the formula:

index₁=W*(k−1)+w, (5)

where the count value of the k^{th} cell of the first memory array exceeds a first threshold value, and the count value of the w^{th} cell of the second memory array exceeds a second threshold value. In another embodiment of the invention, the index can be calculated according to the formula:

index₂=K*(w−1)+k, (6)

After generating the index, in step 606, the count value of the k^{th} cell of the first memory array and the count value of the w^{th} cell of the second memory array are set to the half-threshold value. The count values of rest of cells are reset to zero.

In other device embodiments, an apparatus for detecting a periodically appearing pattern in a bit stream is provided. Each pattern represents a predetermined value, and the period of the plurality of regularly appearing patterns is N bits. FIG. 7 shows another diagram of a system for detecting a regularly appearing pattern in a stream of symbols. The apparatus comprises a detector 72, a first counter array 74, a second counter array 76, and a processor 78. The detector 72 receives a bit of the bit stream, combines the bit with previously received bits to form a plurality of detecting bits, compares the detecting bits with the predetermined bits value, and generates a detection signal while the value of the detecting bits equal to the predetermined bits value. The detecting bits are of predetermined bit length and correspond to a bits location in the bit stream, and the bits location is one of N possible bit locations. The first counter array 72 has K counters, wherein each counter corresponds to a plurality of bits locations of N possible bits locations. When receiving the detection signal, a first pointer points to the counter of the first counter array 74 corresponding to the bits location of the detecting bits. The pointed counter increases by one. The second counter array 76 has W counters, wherein each counter corresponds to a plurality of bits locations of N possible bits locations, and the product of K and W equals N. When receiving the detection signal, a second pointer points to the counter of the second counter array 76 corresponding to the bits location of the detecting bits. The pointed counter increases by one. The processor 78 determines whether the periodically appearing pattern is detected or not according to the counters of the first counter array 74 and counters of the second counter array 76. For example, when the k^{th} counter of the first counter array 74 exceeds a first threshold and/or w^{th} counter of the second counter array exceeds a second threshold, the processor determines processor determines the (k+K*(w−1))^{th} of the N possible bits locations as the bits location of the periodically appearing pattern.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for detecting a regularly appearing pattern in a stream of symbols, wherein the pattern represents a predetermined value and has a predetermined bit length, and the period of the regularly appearing pattern is N bits, the system comprising:
a detector receiving a bit from the stream of symbols, combined the bit with previously received bits to form a plurality of detecting bits, comparing the detecting bits with the predetermined value, and generating a detection signal when the detecting bits equal the predetermined value, wherein the detecting bits are of predetermined bit length;
a first memory array having K cells;
a first pointer initially pointing to a 1^{st} cell of the first memory array, then pointing to the next cell of the first memory array when a bit is received, and when pointing to the K^{th} cell of the first memory array, the first pointer then pointing to the 1^{st} cell of the first memory array, and the count value of the cell pointed to by the first pointer incremented by one when receiving the detection signal;
a second memory array having W cells;
a second pointer initially pointing to a 1^{st} cell of the second memory array, then pointing to the next cell of the second memory array when a symbol is received, and when pointing to the W^{th} cell of the second memory array, the second pointer then pointing to the 1^{st} cell of the second memory array, and the count value of the cell pointed to by the second pointer incremented by one when receiving the detection signal; and
a processor determining whether the regularly appearing pattern is detected or not according to the count values of the first and the second memory array.

2. The system as claimed in claim 1, wherein the predetermined bits length is 8 bits.

3. The system as claimed in claim 1, wherein the product of K and W equals N.

4. The system as claimed in claim 3, wherein the processor determines the regularly appearing pattern has been detected when a cell in the first memory array has a count value exceeding a first threshold and a cell in the second memory array has a count value exceeding a second threshold.

5. The system as claimed in claim 4, wherein the processor further calculates the location of the regularly appearing pattern by the formula:
w+W*(k−1),
where the k^{th} cell in the first memory array with the count value exceeds the first threshold, and the w^{th} cell of the second memory array with count value exceeds the second threshold.

6. The system as claimed in claim 4, wherein the processor further calculate the location of the regularly appearing pattern by the formula:
k+K*(w−1),
where the k^{th} cell in the first memory array with the count value exceeds the first threshold, and the w^{th} cell of the second memory array with count value exceeds the second threshold.

7. The system as claimed in claim 1, wherein the stream of symbols is an MPEG-2 transport stream, and the predetermined value is 47_{HEX}.

8. A system for detecting a regularly appearing pattern in a stream of symbols, wherein each pattern represents a predetermined value, and the period of the regularly appearing pattern is N bits, the system comprising:
a detector receiving a bit from the stream of symbols, combined the bit with previously received bits to form a plurality of detecting bits, comparing the detecting bits with the predetermined value, and generating a detection signal when the detecting bits equal to the predetermined value, wherein the detecting bits is of predetermined bit length;
a counter, incrementing a counter value when a bit is received;
a first memory array having K cells, wherein each cell stores a count value;
a second memory array having W cells, wherein each cell stores a count value;
a processor coupled to the detector, the counter, the first and second memory array, generating a first index by taking the remainder of dividing the count value with K, generating a second index by taking the remainder of dividing the count value with W, and increasing the count value of a cell associated with the first index in the first memory array and increasing the count value of a cell associated with the second index in the second memory array when receiving a detection signal, and determining whether the regularly appearing pattern is detected or not according to the count value of the first and the second memory arrays.

9. The system as claimed in claim 8, wherein the product of K and W equals N.

10. The system as claimed in claim 9, wherein the processor determines the regularly appearing pattern is detected when a cell in the first memory array has a count value exceeding a first threshold and a cell in the second memory array has a count value exceeding the second threshold.

11. The system as claimed in claim 10, wherein the processor further calculates the location of the plurality of regularly appearing patterns by the formula:
(w+1)+(W*k),
where the k^{th} cell in the first memory array with the count value exceeds the first threshold, and the w^{th} cell of the second memory array with count value exceeds the second threshold.

12. The system as claimed in claim 10, wherein the processor further calculate the location of the plurality of regularly appearing patterns by the formula:
(k+1)+(K*w),
where the k^{th} cell in the first memory array with the count value exceeds the first threshold, and the w^{th} cell of the second memory array with count value exceeds the second threshold.

13. The system as claimed in claim 8, wherein the stream of symbols is an MPEG-2 transport stream, and the predetermined value is 47_{HEX}.

14. A method for detecting a regularly appearing pattern in a stream of symbols, wherein the pattern is of a predetermined value and of a predetermined bit length, and the period of the regularly appearing pattern is N bits, the method comprising:
receiving a bit of the stream of symbols and generating a detection signal when detecting the pattern;
providing a first memory array having K cells, wherein each cell stores a count value;
providing a first pointer initially pointing to a 1^{st} cell of the first memory array, then pointing to the next cell of the first memory array when receiving the bit of the stream of symbols, when pointing to a K^{th} cell of the first memory array, the first pointer pointing to the 1^{st} cell of the first memory array, and the content of the cell pointed to by the first pointer incremented by one when the detection signal is received;
providing a second memory array having W cells, wherein the sum of K and W is less than the period, and each cell stores a count value; and
providing a second pointer initially pointing to a 1^{st} cell of the second memory array, pointing to the next cell of the second memory array when receiving the bit of the stream of symbols, when pointing to a W^{th} cell of the second memory array, the second pointer pointing to the 1^{st} cell of the second memory array, and the content of the cell pointed to by the second pointer incremented by one when the detection signal is received; and
generating an index indicating the regularly appearing pattern is detected according to the count values of the first and second memory arrays.

15. The method as claimed in claim 14, wherein the product of K and W equals N.

16. The method as claimed in claim 15, wherein the index is generated according to the formula:
index=W*(k−1)+w,
where the k^{th} cell of the first memory array with the count value exceeds a first threshold value, and the w^{th} cell of the second memory array with the count value exceeds the second threshold value.

17. The method as claimed in claim 15, wherein the index is generated according to the formula:
index=K*(w−1)+k,
where the k^{th} cell of the first memory array with the count value exceeds a first threshold value, and the w^{th} cell of the second memory array with the count value exceeds a second threshold value.

18. The method as claimed in claim 15, further comprising resetting the count values of all cells of the first and second memory arrays after generating the index.

19. The method as claimed in claim 16, further comprising updating the count value of the k^{th} cell of the first memory array to a half-threshold value, and updating the count value of the w^{th} cell of the second memory array to the half-threshold value.

20. The method as claimed in claim 17, further comprising updating the count value of the k^{th} cell of the first memory array to a half-threshold value, and updating the count value of the w^{th} cell of the second memory array to the half-threshold value.

21. The method as claimed in claim 14, wherein the stream of symbols are MPEG-2 transport packet.

22. The method as claimed in claim 18, wherein the predetermined pattern, 47_{HEX}, is an MPEG-2 sync pattern.

23. The method as claimed in claim 14, wherein K is 47, W is 32, and the period is 1504.

24. An apparatus for detecting a periodically appearing pattern in a bit stream, wherein the pattern has predetermined bit length and represents a predetermined bits value, the period of the regularly appearing pattern is N bits, and the apparatus comprising:
a detector receiving a bit of the bit stream, combining the bit with previously received bits to form a plurality of detecting bits, comparing the detecting bits with the predetermined bits value, and generating a detection signal while the value of the detecting bits equal to the predetermined bits value, wherein the detecting bits is of predetermined bit length and corresponds to a bits location in the bit stream, and the bits location is one of N possible bit locations;
a first counter array having K counters, wherein each counter corresponds to a plurality of bits locations of N possible bits locations, and while receiving the detection signal the counter of the first counter array corresponding to the bits location of the detecting bits is increased by one;
a second counter array having W counters, wherein each counter corresponds to a plurality of bits locations of N possible bits locations, and while receiving the detection signal the counter corresponding to the bits location of the detecting bit is increased by one; and
a processor determining whether the periodically appearing pattern is detected or not according to the counters of the first counter array and counters of the second counter array.

25. The apparatus as claimed in claim 24, wherein the apparatus further comprises a first pointer points to the counter of the first counter array corresponding to the bits location of the detecting bits.

26. The apparatus as claimed in claim 24, wherein the apparatus further comprises a second pointer points to the counter of the second counter array corresponding to the bits location of the detecting bits.

27. The apparatus as claimed in claim 24, wherein the product of K and W equals N.

28. The apparatus as claimed in claim 27, wherein the processor determines the periodically appearing pattern has been detected when a counter of the first counter array exceeds a first threshold.

29. The apparatus as claimed in claim 27, wherein the processor determines the periodically appearing pattern has been detected when a counter of the second counter array exceeds a second threshold.

30. The apparatus as claimed in claim 27, wherein the processor determines the periodically appearing pattern has been detected when a counter of the first counter array exceeds a first threshold and a counter of the second counter array exceeds a second threshold.

31. The apparatus as claimed in claim 30, wherein the counter exceeds the first threshold is the k^{th} counter of the first counter array, and the counter exceeds the second threshold is the w^{th} counter of the second counter array, and processor determines the (w+W*(k−1))^{th} of the N possible bits locations as the bits location of the periodically appearing pattern.

32. The apparatus as claimed in claim 30, wherein the counter exceeds the first threshold is the k^{th} counter of the first counter array, and the counter exceeds the second threshold is the w^{th} counter of the second counter array, and processor determines the (k+K*(w−1))^{th} of the N possible bits locations as the bits location of the periodically appearing pattern.

33. The apparatus as claimed in claim 24, wherein the stream of symbols is an MPEG-2 transport stream, and the predetermined bits value is 47_{HEX}.

34. The apparatus as claimed in claim 24, wherein the apparatus further comprises a first pointing counter, and the first pointing counter initializes at 0, and increases by 1 when receiving the bit of the bit stream, and returns to 0 when exceeds (K−1), and while the first pointing counter equals X the first pointer points to the X^{th} counter of the first counter array.

35. The apparatus as claimed in claim 24, wherein the apparatus further comprises a second pointing counter, and the second pointing counter initializes at 0, and increases by 1 when receiving the bit of the bit stream, and returns to 0 when exceeds (W−1), and while the second pointing counter equals Y the second pointer points to the Y^{th} counter of the second counter array.

36. The apparatus as claimed in claim 24, wherein the apparatus further comprises a third pointing counter, and the pointing counter initializes at 0, and increases by 1 when receiving the bit of the bit stream, and returns to 0 when exceeds (N−1).

37. The apparatus as claimed in claim 36, wherein the first pointer points to the N^{th} counter of the first counter array, and N equals to the pointing counter mode (K−1).

38. The apparatus as claimed in claim 36, wherein the second pointer points to the M^{th} counter of the first counter array, and M equals to the pointing counter mode (W−1).
